(19) United States
(12) Patent Application Publication
(10) Pub. No.: US 2019/0193858 A1
(43) Pub. Date: Jun. 27, 2019

(54) SYSTEM FOR MONITORING A PASSENGER CABIN

(71) Applicant: Airbus Operations GmbH, Hamburg (DE)

(72) Inventors: Jörg Stoeffler, Neu Wulmstorf (DE); Axel Kloehn, Hamburg (DE); Holger Mehrholz, Heeslingen (DE)

(73) Assignee: Airbus Operations GmbH, Hamburg (DE)

(21) Appl. No.: 16/229,461

(22) Filed: Dec. 21, 2018

(30) Foreign Application Priority Data
Dec. 21, 2017 (DE) 20 2017 107 834.5

(51) Int. Cl. B64D 11/00; H04N 5/225

(52) U.S. Cl. CPC B64D 11/0015; H04N 5/2253

(57) ABSTRACT

A system for monitoring a passenger cabin, in particular a passenger cabin of an aircraft, has a power supply channel (PSC) having a recess and extending longitudinally in a passenger cabin, wherein the recess points in the direction of the passenger cabin, a multiplicity of power supply unit modules (PSU) for arrangement in the recess, a multiplicity of cover modules for partially covering the recess, wherein the multiplicity of power supply unit modules and the multiplicity of cover modules can be arranged in the power supply channel such that the recess is partially covered by the multiplicity of power supply unit modules and the multiplicity of cover modules in the longitudinal orientation of the power supply channel in the direction of the passenger cabin, and at least one camera for capturing images of at least one part of the passenger cabin.

### FIELD OF THE INVENTION

The present invention relates to a system for monitoring a passenger cabin, in particular a passenger cabin of an aircraft. Further, the present invention relates to a passenger aircraft having such a system.

### BACKGROUND OF THE INVENTION

More and more private and public areas are being video-monitored. In passenger cabins of aircraft too, there is an increased demand for monitoring systems. The practice of monitoring passenger cabins by video has fundamentally been known for a long time (see e.g. what is known as the cabin video monitoring system (CVMS)). In particular, there are regulations that call for cockpit door monitoring (e.g. cockpit door monitoring system (CDSS)).

US20070057785 relates to a wireless cabin monitoring system whose power is supplied via what are known as power rails.

Further, DE 102014101895 describes modular supply channel modules for light, air, emergency oxygen or information that, as a result of lower wiring complexity and simpler fitting, are suitable for producing a flexible seat configuration. In this case, two modules can swap their position without this requiring the position of the other modules to be altered. In general, the capture options for sensitive, but not very visible locations (“hidden areas”) in a passenger cabin (in particular in an aircraft), such as e.g. the areas in front of toilets, galleys or partition dividers, can be limited.

### BRIEF SUMMARY OF THE INVENTION

An aspect of the present application may provide a flexibly arrangeable system for monitoring a passenger cabin that allows optimized visual capture of the “hidden areas”, and wherein the at least one camera blends into the rest of its surroundings as inconspicuously as possible.

The system according to an embodiment of the invention for monitoring a passenger cabin has a supply channel (PSC) having a recess. This recess can be arcuate or u-shaped, for example. The supply channel extends longitudinally in a passenger cabin. In this case, the recess or the open area thereof points in the direction of the passenger cabin. Further, the system comprises a multiplicity of supply unit modules (“PSU modules”) for arrangement in the recess. Such PSU modules are typically the oxygen supply, reading lights or information displays (seatbelt sign, no smoking, etc.). The system also comprises a multiplicity of cover modules for partially covering the recess, wherein the supply unit modules and the cover modules can be arranged in the supply channel such that the recess is partially covered by supply unit modules and cover modules in the longitudinal orientation of the supply channel in the direction of the passenger cabin. The cover modules are used as a placeholder and cover more or less where there is no supply unit module, and where the passenger is not supposed to sit below the bare wiring in the PSC. Furthermore, the system has at least one camera for capturing images of at least one part of the passenger cabin, preferably of the possibly not very visible areas (“hidden areas”).

According to an embodiment of the invention, the system further comprises at least one camera module for arrangement in the recess. In this case, the multiplicity of supply unit modules are arranged in the recess with the multiplicity of cover modules and the at least one camera module such that the recess is coverable completely. Additionally, the at least one camera module has an integrally designed bracket for a camera with a shallow vertical angle of view. This means that the camera is able, on the basis of its shallow angle of view, to capture not necessarily just passenger seat areas situated directly below it, but rather can provide an overview of multiple rows of seats and therefore in particular also of the possibly not very visible areas of the galley, the toilets or partition dividers. The lens for the camera can be a normal, conventional lens. If required, that is to say to capture a larger area of the passenger cabin, a fisheye lens is also possible, however. Depending on how many areas are supposed to be captured with what accuracy, a more or less strongly distorting lens can be used. The possibility of integrating many cameras (with little or no distortion) into a supply channel inconspicuously thus also increases the quality of the captured images, i.e. of the image accuracy. The flexibly positionable camera modules in particular allow the camera(s) to be arranged as is necessary for optimum capture of the not very visible areas.

The at least one camera preferably has a vertical angle of view of approximately 10° to 20°, in particular 15°. This angle range allows capture of images of a larger passenger area with good image quality.

The proposed modular system is preferably designed such that the recess has rails for mounting the multiplicity of supply unit modules, the multiplicity of cover modules and the at least one camera module. This allows faster and easier swapping of the modules and adaptation of the PSC to suit the desired cabin configuration of the aircraft.

In particular, the at least one camera is connected to a display for presenting the captured images of the at least one part of the passenger cabin via a network switch (area distribution unit (ADU)) and via a video control unit (video controller). This display can be a separate display of a personal electronic device (PED) of the aircraft crew, in particular a mobile display of a tablet or of a smart watch is conceivable. It can alternatively be coupled to a cabin management system present in the passenger aircraft, e.g. via what is known as the flight attendant panel (FAP). In this way, flight attendants have the opportunity to quickly notice abnormalities in not very visible areas.

The present application in particular also relates specifically to a passenger aircraft having the proposed modular system for monitoring a passenger cabin. The monitored areas can in this case, as already described above, be presented via a cabin management system. In particular, the recorded image content can be buffer-stored in a separate server for the aircraft, so that it can be downloaded, if need be also as required. This would be the case e.g. if violence (“rude behaviour”) were to arise on the flight and evidence needs to be saved. Alternatively, the recorded image content can be transmitted with suitable data compression to another receiver directly or via satellite. Said receiver could be e.g. on the ground, but transmission to another aircraft is also conceivable.

### BRIEF DESCRIPTION OF THE DRAWINGS

The invention is explained below with reference to the drawings.

FIG. 1 shows a perspective view of a supply channel having a supply unit module and a camera module (without a camera), which are both arranged in the recess and are mounted on rails.

FIG. 2 shows a perspective view of the camera module according to the invention.

FIG. 3 shows a perspective view of the system according to the invention.

FIG. 4 shows a block diagram of the supply of the camera and the flow of data from the camera.

### DETAILED DESCRIPTION

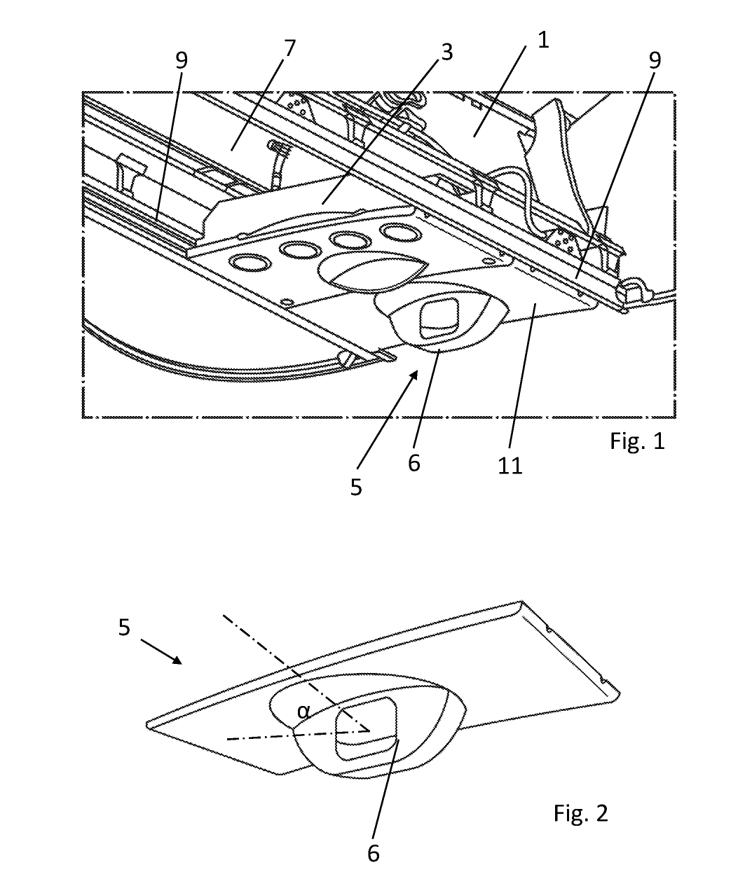

FIG. 1 shows a perspective view of a supply channel 1 having a supply unit module 3 and a camera module 5 (without a camera), which are both arranged in the recess 7 of the supply channel 1 and are mounted on rails 9. The camera module 5 firstly has a largely planar area 11 (see FIG. 2). This planar area 11 forms the ceiling (together with cover modules and further supply unit modules; not shown in FIG. 1) visible to a passenger sitting beneath the supply channel when the camera module 5 is installed in the recess 7 of the supply channel 1 by means of the rails 9. Secondly, the camera module 5 has an integrally designed bracket 6 for the camera, so that the vertical angle of view α of the latter for capturing the passenger space is approximately 10° to 20°, in particular 15° (see FIG. 2). As a result of this shallow angle, the camera projects only insubstantially over the planar area 11. It is in particular conceivable for the bracket to have a similar appearance to e.g. the oxygen supply, reading lights or information displays (e.g. seatbelt sign, no smoking) for passengers, for example.

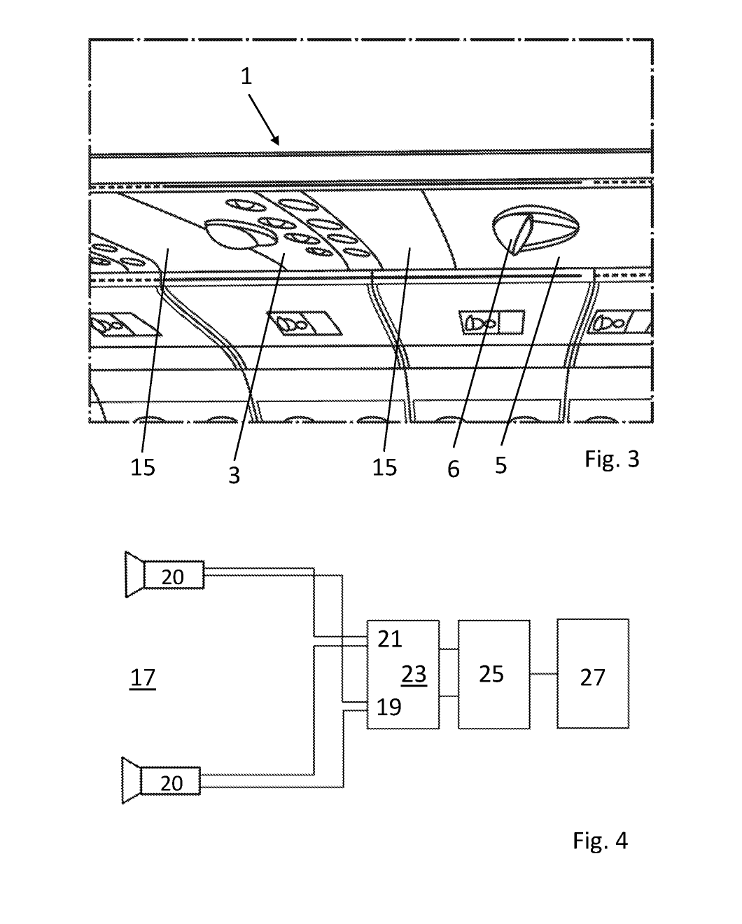

FIG. 3 shows an exemplary design of a system 13 according to the invention for monitoring a passenger cabin of an aircraft having a supply channel 1, extending longitudinally in a passenger cabin, and having a supply unit module 3 and also a multiplicity of cover modules 15 for partially covering the recess 7. Further, the system 13 has at least one camera module 5 having an integrally designed bracket 6 in which a camera for capturing images of at least one part of the passenger cabin can be arranged and is held in a desired position by the bracket. The vertical angle of view α of the camera is in this case preferably approximately 10° to 20°, in particular 15°. For the sake of clarity, it should be noted that the vertical angle of view α is in this case situated between the supply channel 1 extending over the passenger seats and the perpendicular from the supply channel in the direction of the passenger seats.

Finally, FIG. 4 shows a block diagram 17 for the supply 19 of the camera 20 and the data connection 21 from the camera. The at least one camera for capturing images of at least one part of the passenger cabin, in particular of a not very visible area, is in this case situated in a camera module arranged in a supply channel. The two cameras 20 are connected to a video control unit 25 via a network switch 23 (what is known as the area distribution unit, ADB) and via a data connection 21 and also a supply 19. In this way, the image data captured by the cameras 20 can be forwarded via the data connection 21 to the video controller and subsequently then for example to a display 27 or a display unit, where e.g. a stewardess keeps an eye on the presented parts of the passenger cabin. This can be a personal electronic device (PED), for example, such as a tablet or a smart watch (what are known as wearable devices), for example.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

1 supply channel
3 supply unit module
5 camera module
6 integrally designed bracket
7 recess of the supply channel
9 rails
11 planar area
13 system according to the invention
15 multiplicity of cover modules
17 block diagram
19 supply
21 data connection
23 network switch (area distribution unit, ADB)
25 video control unit
27 display
α vertical angle of view

1. A system for monitoring a passenger cabin, the system comprising:
a power supply channel having a recess and extending longitudinally in a passenger cabin, wherein the recess points in the direction of the passenger cabin;
a multiplicity of power supply unit modules for arrangement in the recess;
a multiplicity of cover modules for partially covering the recess;
wherein the multiplicity of power supply unit modules and the cover modules are configured to be arranged in the power supply channel such that the recess is partially covered by the multiplicity of power supply unit modules and the multiplicity of cover modules in the longitudinal orientation of the power supply channel in the direction of the passenger cabin, and
at least one camera for capturing images of at least one part of the passenger cabin,
wherein the system further comprises at least one camera module for arrangement in the recess, so that the multiplicity of power supply unit modules is configured to be arranged in the recess with the multiplicity of cover modules and the at least one camera module such that the recess is coverable completely, and wherein the at least one camera module has an integrally designed bracket for a camera, so that the vertical angle of view α of the latter is a shallow angle.

2. The system according to claim 1, wherein the vertical angle of view α is approximately 10° to 20°.

3. The system according to claim 1, wherein the recess has rails for mounting the multiplicity of power supply unit modules, the multiplicity of cover modules and the at least one camera module.

4. The system according to claim 1, wherein the at least one camera is connected to a display for presenting the captured images of the at least one part of the passenger cabin via a network switch and a video control unit.

5. A passenger aircraft comprising a system according to claim 1.
